(19) United States
(12) Patent Application Publication
(10) Pub. No.: US 2006/0198441 A1
(43) Pub. Date: Sep. 7, 2006

(54) MOTION DETECTION METHOD FOR DETECTING MOTION OBJECTS IN VIDEO FRAMES GENERATED FROM A VIDEO SURVEILLANCE SYSTEM

(76) Inventor: Hua-Chang Chi, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,703

(22) Filed: Mar. 2, 2005

(51) Int. Cl. H04N 11/02; H04N 7/18; H04N 11/04; H04N 9/47; H04N 7/12; H04B 1/66

(52) U.S. Cl. 375/240.16; 375/240.24; 348/143

(57) ABSTRACT

A motion detection method for detecting motion objects in video frames generated from a video surveillance system. The motion detection method includes the steps of (1) calculating and accumulating a number of a current macro block row by row, the current macro block having a motion vector, which has a predetermined characteristic and a predetermined relation with a motion vector corresponding to a macro block preceding the current macro block, and a current macro block row where the current macro block stays having a position relation with a macro block row preceding the current macro block of the video frame which the motion objects occupy, and (2) determining the motion objects occupy the video frame when the number is larger than a predetermined value.

### BACKGROUND OF THE INVENTION

1. Field of the Invention

The present invention relates to a video surveillance system, and more particularly, to a motion detection method for detecting motion objects in video frames generated from the video surveillance system.

2. Description of the Prior Art

A motion detection method is usually applied to a video surveillance system. The video surveillance system comprises a video capturing device, a monitor, a motion detector, a recorder, and an alarm. After detecting that a video captured by the video capturing device has motion objects, the motion detector controls the alarm to issue an alarm to notify security personnel, or enables the recorder to record the video.

In statistics, the motion detection method that the motion detector adopts dominates the effectiveness of the video surveillance system to detect the motion objects. A frame difference method, one of the most intuitive and easy-to-understand motion detection methods, compares the difference between a current video frame and a preceding video frame, and determines that the current video frame has at least a motion object if the difference is larger than a predetermined threshold.

In recent years, developed with the explosive progress in digital video techniques, a Moving Picture Expert Group (MPEG), one of the motion detection methods developed in accordance with the modern digital video techniques, is becoming more and more popular. Please refer to FIG. 1, which is a function block diagram of a video surveillance system 1010 developed on a base of the MPEG according to the prior art. The video surveillance system 1010 comprises a video capturing device 1012, an MPEG video encoder 1014, a motion detector 1016, a recorder 1018, and an alarm 1020.

The motion detection method that the motion detector 1016 adopts is called a motion vector method, which determines if the current video frame has any motion objects according to a motion vector calculated by the MPEG video encoder 1014 by encoding video signals captured by the video capturing device 1012.

Please refer to FIG. 2, which is a schematic diagram of a current video frame 1022 and a preceding video frame 1024 in the video surveillance system 10. If a difference between an object block 1026 (usually composed of 8×8 or 16×16 pixels) in the current video frame 1022 and a candidate block in the current video frame 1024, the location where the candidate block is located in the preceding video frame 1024 is the same as that where the object block 1026 is located in the current video frame 1022, is smaller than a predetermined threshold, the object block 1026 is determined to have no motion objects; On the contrary, if the difference between the object block 1026 in the current video frame 1022 and the candidate block in the preceding video frame 1024 exceeds the predetermined threshold, the object block 1026 is determined to have at least a motion object. Through the calculation of the spatial correlation between the object block 1026 and any one of the candidate blocks as large as the object block 1026 in a search area 1028 in the preceding video frame 1024, a motion vector corresponding to the object block 1026 is obtained, and the motion direction and the motion velocity of the motion object in the object block 1026 is determined. All of the object blocks in a still video frame correspond to a motion vector of (0, 0).

The size, and the shape as well, of the search area 1028 relates to the motion velocity and the motion direction of the motion object in the object block 1026 closely. If the motion object in the object block 1026 usually moves left and right in a very high speed, the search area 1028 is recommended to have the shape of a large-sized rectangle. On the contrary, if the motion object moves omni-directionally in a low speed, the search area 1028 is recommended to have the shape of a medium-sized square. The size and the shape of the search area 1028 further relates to the efficiency of the MPEG video encoder 1014 to encode the video signals.

However, the frame difference method, and the motion vector method as well, being applied to a video surveillance system, has a big chance to make an erroneous judgment that a video frame has a motion object when a light is shining on the video frame unexpectedly and the luminance of the video frame changes significantly.

U.S. Pat. No. 6,512,537 disclosed a method to solve the above problem. In U.S. Pat. No. 6,512,537, the method, basing on an assumption that a motion object, for example a thief, occupies only a couple of macro blocks (3×3, as shown in FIG. 6B), each of which includes 16×16 pixels, of a video frame generated from a video surveillance system, and any motion macro block, for example the central macro block of the nine macro blocks, should have a motion vector approximately equal to those of its eight surrounding macro blocks, determines that the motion macro block, which is surrounded by the eight surrounding macro blocks, is a part of a motion object if at least four (for example) surrounding macro blocks of the eight surrounding macro blocks whose motion vectors are approximately equal to that of the motion macro block.

Although the method can solve the above problem if only the motion object occupies exactly nine macro blocks of the video frame generated from the video surveillance system, the motion object in reality can occupy more than or less than nine macro blocks if it is very close to or far away from a video capturing device of the video surveillance system, and the number of the macro blocks where the motion object occupies the video frame is therefore uncertain and is not invariably equal to nine. In conclusion, U.S. Pat. No. 6,512,537 can be applied to specific cases only and still has a big chance to make an erroneous judgment.

### SUMMARY OF INVENTION

It is therefore a primary objective of the claimed invention to provide a motion detection method to solve the above problem. The motion detection method is capable of detecting any motion object of a video frame no matter how many macro blocks the motion object occupies the video frame.

According to the claimed invention, the motion detection method is designed for detecting a motion object in a video frame generated from a video surveillance system. The video frame includes a plurality of macro blocks arranged in matrix. Each of the macro block has a corresponding motion vector. The motion detection method first determines row by row whether a current macro block of the macro blocks of the video frame has a corresponding motion vector having a predetermined characteristic. The method then determines whether the motion vector of the current macro block has a predetermined relation with a motion vector of a macro block preceding the current macro block. The method then determines whether the current macro block is located in a current macro block row having a position relation with a macro block row preceding the current macro block row where the motion object occupies the video frame, the current macro block row comprising at least a macro block whose corresponding motion vector having the predetermined relation with the motion vector of the current macro block. The method then determines whether a current subtotal of macro blocks of the current macro block row has a predetermined magnitude relation with a reference subtotal of macro blocks of a reference macro block row where the motion object occupies a macro block row where the current macro block in located, the reference macro block row including at least a macro block having a corresponding motion vector having the predetermined relation with motion vectors of the remaining macro blocks of the reference macro block row. The method then counts and accumulates row by row a number of a current macro block having a corresponding motion vector determined to have the predetermined characteristic and determined to have the predetermined relation with a motion vector of a macro block preceding the current macro block, a current macro block row where the current macro block is located having been determined to have the position relation with a macro block row preceding the current macro block row where the motion object occupies the video frame, and the current subtotal of macro blocks of the current macro block row having the predetermined magnitude relation with the reference subtotal of the reference macro block row where the motion object occupies a macro block row where the current macro block in located. The method last determines the video frame has the motion object when the number is larger than a third threshold.

The present invention also present a second embodiment. According to the second embodiment of the claimed invention, the motion detection method first determines row by row whether a current macro block of the macro blocks of the video frame has a corresponding motion vector having a predetermined characteristic. The method then determines whether the motion vector of the current macro block has a predetermined relation with a motion vector of a macro block preceding the current macro block. The method then determines whether the current macro block is located in a current macro block row having a position relation with a macro block row preceding the current macro block row where the motion object occupies the video frame, the current macro block row including at least a macro block whose corresponding motion vector having the predetermined relation with the motion vector of the current macro block. The method then counts and accumulates row by row a number of a current macro block having a corresponding motion vector determined to have the predetermined characteristic and determined to have the predetermined relation with a motion vector of a macro block preceding the current macro block, a current macro block row where the current macro block is located having been determined to have the position relation with a macro block row preceding the current macro block row where the motion object occupies the video frame. The method last determines the video frame has the motion object when the number is larger than a third threshold.

It is an advantage of the claimed invention that the motion detection method can be adopted by a video surveillance system. Even when a light is shining unexpectedly on a video frame the video surveillance system generates and the luminance of the video frame has changed significantly, the motion detection method still can detect when the video frame comprises any motion objects successfully. Moreover, the motion detection method does not put any restriction on the number of macro blocks the motion object occupies the video frame. Through a proper amendment of the first threshold T₁, the motion detection method can find any motion objects of any size (occupying more than or less than nine macro blocks) of the video frame.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of a video surveillance system developed on a base of MPEG according to the prior art.

FIG. 2 is a schematic diagram of a current video frame and a preceding video frame in the video surveillance system shown in FIG. 1.

FIG. 3 is a flow chart of a motion detection method of the preferred embodiment according to the present invention.

FIG. 4 is a flow chart of a step of the motion detection method shown in FIG. 3.

FIG. 5 is a flow chart of another step of the motion detection method shown in FIG. 3.

FIG. 6 and FIG. 7 are two schematic diagrams of two overlapping macro blocks.

FIG. 8 and FIG. 9 are two schematic diagrams of two non-overlapping macro blocks.

FIG. 10 is a schematic diagram of a macro block row comprising a plurality of contagious macro block groups of a video frame generated from the video surveillance system shown in FIG. 1.

FIG. 11 is a flow chart of a motion detection method of a second embodiment according to the present invention.

FIG. 12 to FIG. 15 are four flow charts of four steps of the motion detection method shown in FIG. 11.

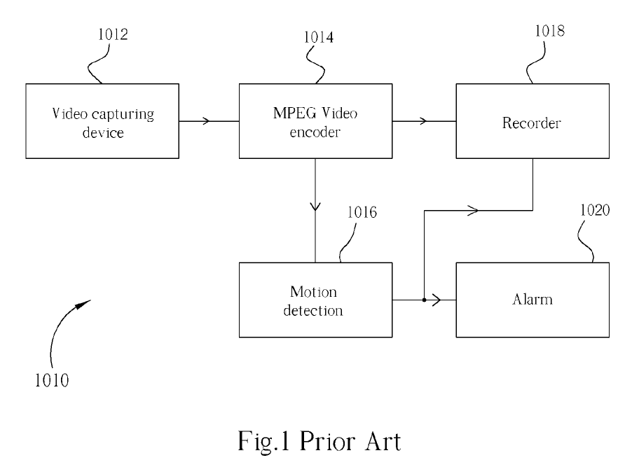

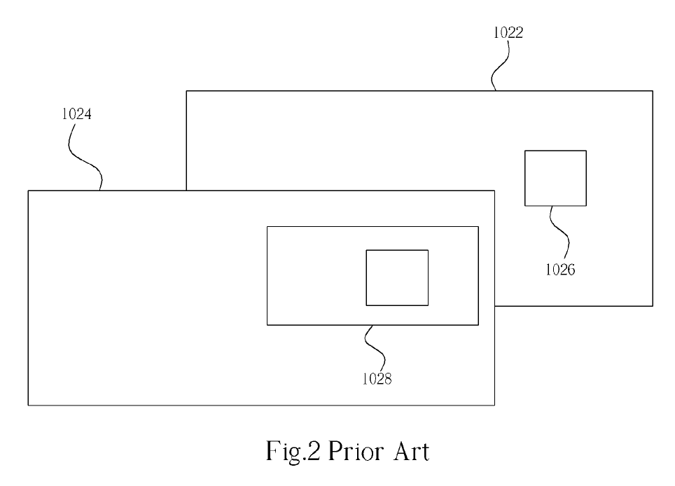

### DETAILED DESCRIPTION

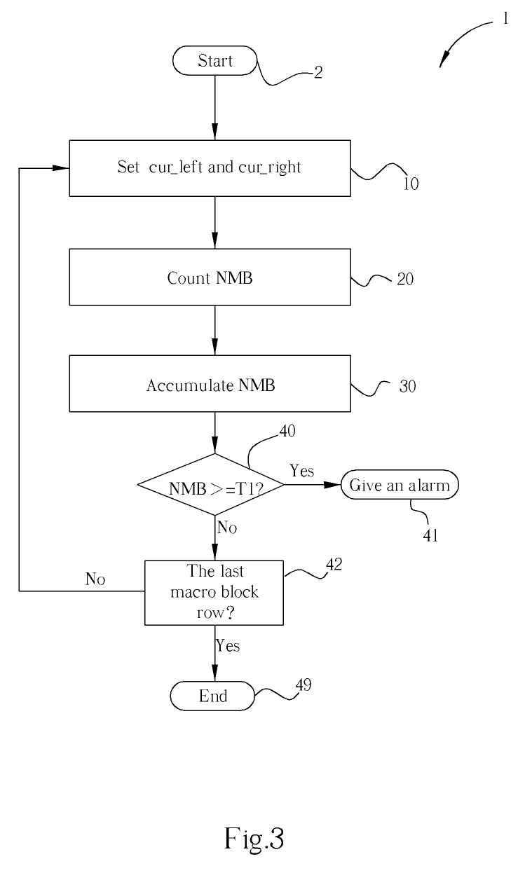

Please refer to FIG. 3, which is a flow chart of a motion detection method 1 of the preferred embodiment according to the present invention. For easy description, each of the video frames the video surveillance system 1010 generates in the motion detection method 1 is assumed to include only one motion object and each row of the video frame is assumed to be occupied by at most one macro block group, which will be defined later. The video frame are segmented into a plurality of macro blocks arranged in matrix. The motion detection method 1 counts and accumulates row by row the number of the macro blocks NMB where the motion object occupies each of the macro block rows of the video frame. The motion detection method 1 comprises the following steps:

Step 2: Start;

(In the beginning, NMB is set to be “0”, and i is set to be “1”. In words, the motion detection method 1, from the first macro block row, counts and accumulates the number of the macro blocks NMB where the motion object occupies the video frame row by row.)

Step 10: Initialize cur_left and cur_right;

(Cur_left and cur_right are set to be “0” and “−1” respectively, where cur_left indicates a left margin of an ith macro block segment including at least one macro block where the motion object occupies the ith macro block row a video frame including a plurality of macro blocks arranged in matrix, and cur_right a right margin of the macro block segment.)

Step 20: Count the number of macro blocks NMB where the motion object occupies the ith macro block row;

(In step 20, both cur_left and cur_right will be updated as a position or a size of the ith macro block segment where the motion occupies the ith macro block row change. How cur_left and cur_right are updated will be explained later. A number of (cur_right−cur_left+1) indicates how many macro blocks the motion object occupies the ith macro block row. For example, if the motion object does not occupy any macro block of the ith macro block row, both cur_left and cur_right will not be updated, and the motion object occupies (cur_right−cur_left+1)=(−1−0+1)=0 macro blocks of the ith macro block row.)

Step 30: Accumulate a total number of macro blocks where the motion object has occupied the video frame from the first macro block row to the ith macro block row;

(That is, NMB=NMB+(cur_right−cur_left+1).)

Step 40: Determine if NMB is larger than a first threshold T₁? If NMB is larger than the first threshold T₁, then go to step 41, else go to step 42;

Step 41: Give an alarm;

(So far, the motion detection method 1, up to the ith macro block row, has “found” the motion object of the video frame, and the motion detector 1016 of the video surveillance system 1010, which adopts the motion detection method 1, controls the alarm 1020 to issue an alarm to notify security personnel, or enables the recorder 1018 to record the video.)

Step 42: Determine if the ith macro block row is the last macro block row of the video frame? If the ith macro block row is the last macro block row of the video frame, then go to step 49, else i=i+1 and go to step 10; and

(So far, the motion detection method 1, up to the ith macro block row, cannot make a decision whether the video frame has the motion object, and have to count and accumulate the number of macro blocks NMB where the motion object occupies the remaining macro block rows succeeding the ith macro block row of the video frame.)

Step 49: End.

(So far, the motion detection method 1 has detected all of the macro blocks of the video frame and does not find any motion object.)

The motion detection method 1, through the detection of all of the macro blocks of the video frame the video surveillance system 1010 generates, is capable of determining if the video frame has a motion object, which can occupy macro blocks of any number, in addition to nine macro blocks, of the video frame, so as to overcome the problem of erroneous judgment.

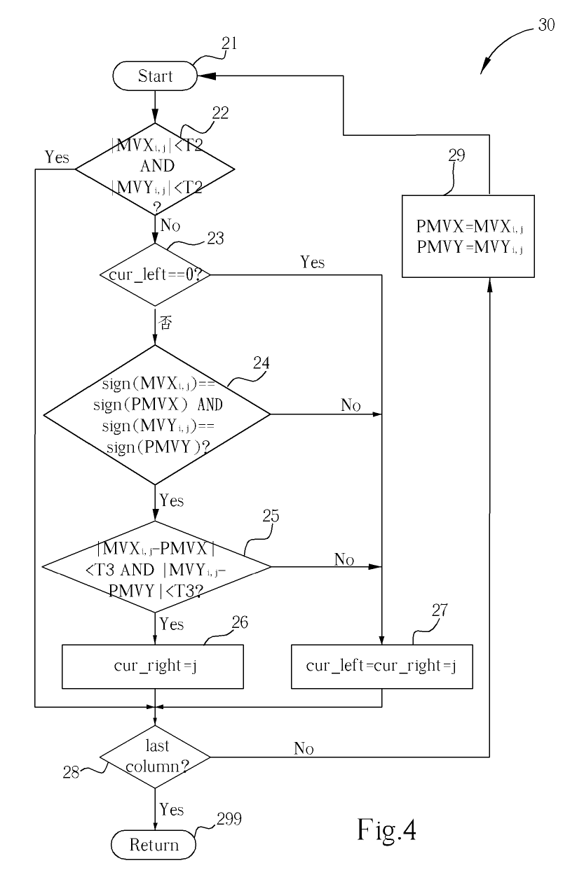

Step 20 of the motion detection method 1—Count the number of macro blocks NMB where the motion object occupies the ith macro block row, the definition of the macro block group, and how cur_left and cur_right are updated are explained in detail in the following paragraphs. Please refer to FIG. 4, which is a flow chart of step 20 of the motion detection method 1. Step 20 comprises the following steps:

Step 21: Start;

(J is initialized to be “1”. In words, the motion detection method 1, from the first macro block column of the ith macro block row, counts the number of the macro blocks NMB where the motion object occupies the ith macro block row of the video frame column by column.)

Step 22: Determine if both |MVX_{i,j}| and |MVY_{i,j}| are smaller than a second threshold T₂? If both |MVX_{i,j}| and |MVY_{i,j}| are smaller than the second threshold T₂, then go to step 28, else go to step 23;

((MVX_{i,j},MVY_{i,j}) indicates a motion vector MV_{i,j} corresponding to a macro block MB_{i,j} located in the jth macro block column of the ith macro block row, where |MVX_{i,j}|is an x component of the motion vector MV_{i,j}, and |MVY_{i,j}|a y component of the motion vector MV_{i,j}. If either of |MVX_{i,j}| and |MVY_{i,j}| is larger than the second threshold T₂, the macro block MB_{i,j} is determined to be a motion block.)

Step 23: Determine if cur_left is equal to “0”? If cur_left is equal to “0”, then go to step 27, else go to step 24;

(Having been determined to be a motion block in step 22, the macro block MB_{i,j} has to be further determined if it is a start macro block. If cur_left is still equal to “0”, which implies that cur_left has never been updated, the macro block B_{i,j} is determined to be a first macro block where the motion object occupies the ith macro block row, and the macro block B_{i,j} is called the start macro block. Then, both cur_left and cur_right are set to be “j”. The motion detection method 1 detects that the motion object occupies only (cur_right−cur_left+1)=(j−j+1)=1 macro block of the ith macro block row.)

Step 24: Determine if sign(MVX_{i,j}) and sign(MVY_{i,j}) are equal to sign(PMVX) and sign(PMVY) respectively? If sign (MVX_{i,j}) is equal sign(PMVX) and sign(MVY_{i,j}) is equal to sign(PMVY), then go to step 25, else go to sep 27;

(Having been determined to be an intermediate macro block, the macro block MB_{i,j} has to be further determined if it moves together with a preceding macro block MB_{preceding}, a macro block arranged right preceding the macro block MB_{i,j}. (PMVX,PMVY) indicates a motion vector MV_{preceding} corresponding to the preceding macro block, and sign(x) a sign of an variable x. If sign(MVX_{i,j}) and sign(MVY_{i,j}) are equal to sign(PMVX) and sign(PMVY) respectively, the macro block MB_{i,j} is determined to move together with the preceding macro block MB_{preceding}, or the macro block MB_{i,j} is determined to be included in a macro block group different from that in which the preceding macro block MB_{preceding} is included, a macro block group comprising at least a macro block whose corresponding motion vectors are approximately equal to each other and move toward the same direction at the same speed. Since the video surveillance system 1010 is assumed to generate a video frame having only one motion object, and the motion object is assumed to occupy only one macro block group per macro block row, the motion detection method 1 will not go from step 24 to step 27.)

Step 25: Determine if both |MVX_{i,j}−PMVX| and |MVY_{i,j}−PMVY| are smaller than a third threshold T₃? If both |MVX_{i,j}−PMVX| and |MVY_{i,j}−PMVY| are smaller than the third threshold T₃, then go to step 26, else go to step 27;

(Having been determined to move together with the preceding macro block MB_{preceding}, the macro block MB_{i,j} has to be further determined if it is included in a macro block group in which the preceding macro block MB_{preceding} is included. Since the motion vectors the macro blocks of a macro block groups respectively correspond are approximately equal to each other, if both |MVX_{i,j}−PMVX| and |MVY_{i,j}−PMVY| are smaller than the third threshold T₃, the macro block MB_{i,j} is determined to be included in a macro block group in which the preceding macro block MB_{preceding} is included, or the macro block MB_{i,j} is determined to be included in a macro block group in which the preceding macro block MB_{preceding} is not included. Similarly, since the video surveillance system 1010 is assumed to generate a video frame having only one motion object, and the motion object is assumed to occupy only one macro block group per macro block row, the motion detection method 1 will not go from step 25 to step 27.)

Step 26: Set cur_right to be “j”, then go to step 28;

(Having been determined to be included in a macro block group in which the preceding macro block MB_{preceding} is included and to be arranged in the macro block group right preceding the preceding the preceding macro block MB_{preceding}, cur_right of the macro block segment where the motion object occupies the ith macro block row of the video frame, which comprises a plurality of macro blocks arranged in matrix, is updated to be “j”.)

Step 27: Set both cur_left and cur_right to be “j”, then go to step 28;

(So far, the motion detection method 1 has determined that (1) the macro block MB_{i,j} is the first macro block where the motion object occupies the ith macro block row, and the necessity is omitted to execute steps from 24 to 26, which are those steps to comparing the macro block MB_{i,j} with the preceding macro block MB_{preceding}, because a first macro block does not have any preceding macro block; (2) though the macro block MB_{i,j} is not the start macro block, both cur_left and cur_right of the macro block segment where the motion object occupies the ith macro block row of the video frame still have to be updated for the macro block MB_{i,j} does not move together with the preceding macro block MB_{preceding}, and is included in a macro block group different from that in which the preceding macro block MB_{preceding} in included, and Step 27 is to be executed after the execution of step 24;(3) though macro block MB_{i,j} is not the start macro block, and the macro block MB_{i,j} moves together with the preceding macro block MB_{preceding}, both cur_left and cur_right of the macro block segment where the motion object occupies the ith macro block row of the video frame still have to be updated for a difference between the corresponding motion vectors of the macro block MB_{i,j} and the preceding macro block MB_{preceding} is larger than a predetermined value, i.e. the third threshold T₃, and the macro block MB_{i,j} is included in a macro block group different from that in which the preceding macro block MB_{preceding} in included, and Step 27 is to be executed after the execution of step 25)

Step 28: Determine if the jth macro block column is the last macro block column of the ith macro clock row? If the jth macro block column is the last macro block column of the ith macro clock row, then go to step 299, else j=j+1 and go to step 29;

(The motion detection method 1 does not stop executing steps from 21 to 28 until the last macro block column of the ith macro block row has been detected.)

Step 29: Set both PMVX and PMVY to be “MVX_{i,j}” and “MVY_{i,j}” respectively, then go to step 21; and

Step 299: Return.

(So far, step 20—Count the number of macro blocks NMB where the motion object occupies the ith macro block row—has been executed completely, and the number of the macro blocks where the motion object occupies the ith macro block row is acquired, that is (cur_right−cur_left+1).

In step 22 |MVX_{i,j}| and |MVY_{i,j}| are determined if they are both smaller than the second threshold T₂. Of course, |MVX_{i,j}” and |MVY_{i,j}| can be determined if they are smaller than two thresholds T₂ and T₂′ which are different from each other respectively, depending on any motion characteristics, such as velocity and moving direction, of the motion object moving in the video frame. For example, if the motion object usually moves along a horizontal direction, the threshold T₂ is suggested to be larger than the threshold T₂′. Similarly, in step 25 |MVX_{i,j}−PMVX| and |MVY_{i,j}−PMVY| are determined if they are both smaller than the third threshold T₃. Of course, |MVX_{i,j}−PMVX| and |MVY_{i,j}−PMVY| can be determined if they are smaller than two thresholds T₃ and T₃′ which are different from each other respectively, depending on the motion characteristics of the motion object moving in the video frame.

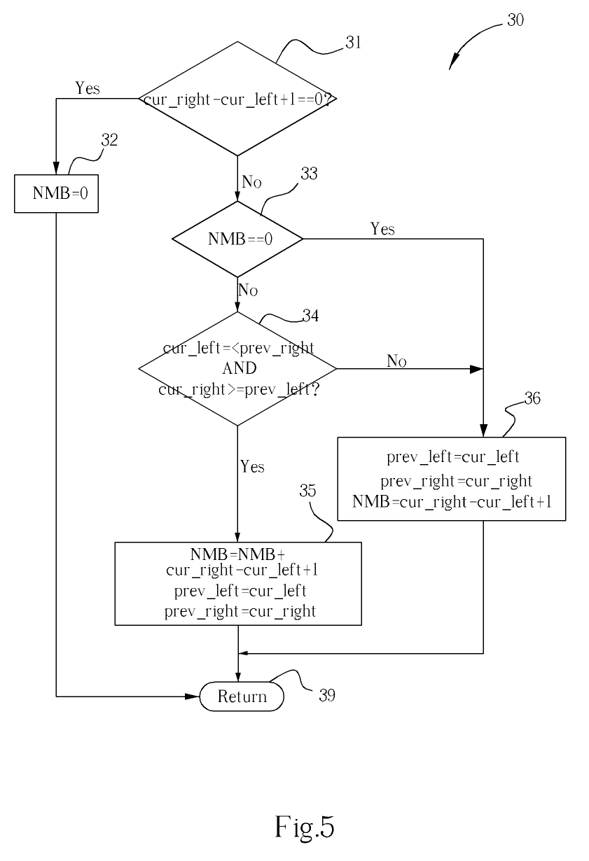

After acquiring the number of the macro blocks where the motion object occupies the ith macro block row of the video frame, the motion detection method 1 then accumulates the number. Please refer to FIG. 5, which is a flow chart of step 30 of the motion detection method 1. Step 30 comprises the following steps:

Step 31: Determine if (cur_right−cur_left+1) is equal to “0”? If (cur_right−cur_left+1) is equal to “0”, then go to step 32, else go to step 33;

(Since (cur_left, cur_right) in step 10 is initially set to be (0,−1), if (cur_right−cur_left+1) is still equal to “0” after the execution of step 20, the ith macro block row of the video frame is determined comprising no motion objects. Whether a motion object occupies any macro blocks of the ith macro block row of the video frame can be determined if (cur_right−cur_left+1) is updated.)

Step 32: Set NMB to be “0”, then go to step 39;

(Since (cur_right−cur_left+1), after the execution of step 20, is still equal to “0”, the ith macro block row can be used to indicate the end of a previous motion object or the beginning of a new motion object, and NMB, which indicates how many macro blocks the new motion object occupies the video frame, has to be reset to be “0”.)

Step 33: Determine if NMB is equal to “0”? If NMB is equal to “0”, then go to step 36, else go to step 34;

(Since (cur_right−cur_left+1), after the execution of step 20, is not equal to “0” any more, the ith macro block row is determined to be occupied by the motion object. If at the same time NMB is equal to “0”, the ith macro block row is determined to be a start macro block row where a motion object occupies the video frame, or a motion object occupying the ith macro block row further occupies the (i−1)th macro block row of the video frame.)

Step 34: Determine if cur_left is not larger than prev_right and cur_right is not smaller than prev_left? If cur_left is not larger than prev_right and cur_right is not smaller than prev_left, then go to step 35, else go to step 36;

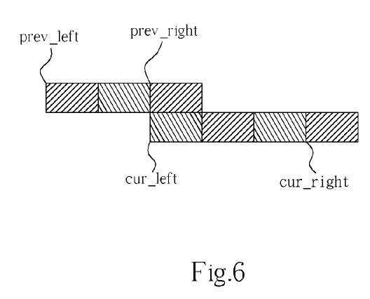

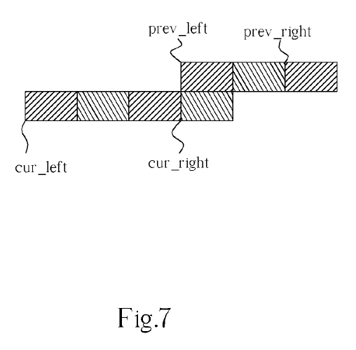

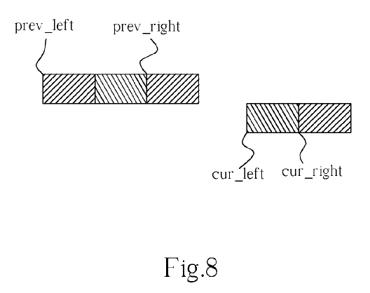

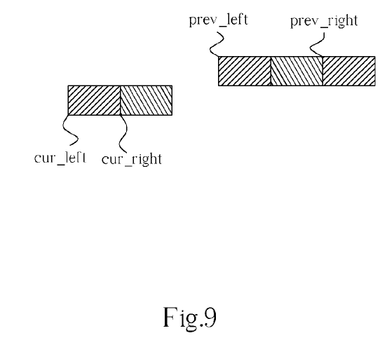

(Prev_left indicates a left margin of a macro block segment where the motion object occupies the (i−1)th macro block row of the video frame, which includes a plurality of macro blocks arranged in matrix, and prev_right a right margin of the macro block segment. After (cur_right−cur_left+1) and NMB are determined that they are both not equal to “0”, the motion object is determined that it, in addition to the ith macro block row, further occupies the (i−1)th macro block row. If cur_left is not larger than prev_right and cur_right is not smaller than prev_left, as shown in FIG. 6 and FIG. 7, the macro block segment where the motion object occupies the (i−1)th macro block row is determined to overlap the macro block segment where the motion object occupies the ith macro block row; On the contrary, if cur_left is larger than prev_right or cur_right is smaller than prev_left, as shown in FIG. 8 and FIG. 9, the macro block segment where the motion object occupies the (i−1)th macro block row is determined not to overlap the macro block segment where the motion object occupies the ith macro block row, and the motion object occupying the (i−1)th macro block row is determined to be distinct from the motion object occupying the ith macro block row. Since the video surveillance system 1010 is assumed to generate a video frame comprising only one motion object, the motion detection method 1 will not go from step 34 to step 36.)

Step 35: Set NMB to be “NMB+cur_right−cur_left+1”, prev_left to be “cur_left”, and prev_right to be “cur_right”, then go to step 39;

(So far, since (cur_right−cur_left+1) and NMB are both determined to be not equal to “0” and the macro block segment where the motion object occupies the (i−1)th macro block row is determined to overlap the macro block segment where the motion object occupies the ith macro block row, (cur_right−cur_left+1) is to be accumulated to NMB, and prev_left is set to be “cur_left” and prev_right to be “cur_right”.)

Step 36: Set prev_left to be “cur_left”, prev_right to be “cur_right”, and NMB to be “cur_right−cur_left+1”, then go to step 39;

(So far, the motion detection method 1 has determined that (1) the macro block segment where the motion object occupies the (i−1)th macro block row does not overlap the macro block segment where the motion object occupies the ith macro block row (from step 34), and the motion object occupying the (i−1)th macro block row is distinct from the motion object occupying ith macro block row, or (2) the ith macro block row is the start macro block row corresponding to the motion object (from step 33).)

Step 39: Return.

(The motion detection method 1 has determined that (1) the ith macro block row of the video frame is not occupied by any motion object (from step 32); (2) the motion object occupies the ith macro block row, and the (i−1)th macro block row as well, of the video frame (from step 35); and (3) the ith macro block row is the start macro block corresponding to the motion object. In any one of the above three events, the motion detection method 1 has accumulates the number of the macro blocks where the motion object occupies the video frame from the first macro block row to the ith macro block row.)

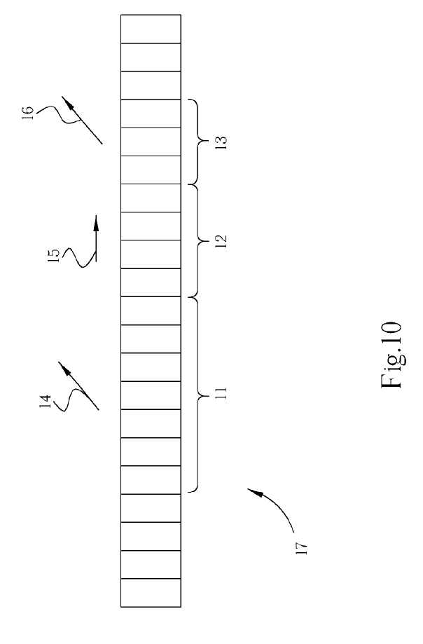

In steps 24 and 25, if a difference between the motion vector MV_{preceding} and the motion vector MV_{i,j} is larger than a predetermined value, for example the second threshold T₂ in step 24 or the third threshold T₃ in step 25, the macro block MB_{i,j} is determined to be included in a macro block group different from that in which the preceding macro block MB_{preceding} is included. Please refer to FIG. 10, which is a schematic diagram of a macro block row 17 comprising a plurality of contagious macro block groups of a video frame generated from the video surveillance system 1010. Three macro block groups 11, 12, and 13 where a motion object (which is a single macro block corresponding to the plurality of contagious macro block groups; On the contrary, if these macro blocks are not contagious, the macro block row 17 is occupied by more than one motion object.) occupies the video frame comprise seven, four, and three macro blocks respectively. All of the macro blocks of each of the macro block groups have corresponding motion vectors approximately equal in velocity and moving direction. For example, all of the macro blocks of the macro block group 11 have corresponding motion vectors approximately equal to a motion vector 14, but the macro blocks of any two neighboring macro block groups have corresponding motion vectors different from each other, a motion vector 15, which is approximately equal to those motion vectors the macro blocks of the macro block group 12 correspond, being different from a motion vector 16, which is approximately equal to those motion vectors the macro blocks of the macro block group 13 correspond, but the motion vector 14 can be approximately equal to the motion vector 16. In order to reduce the possibility of erroneous judgment, a motion detection method of the present invention accumulates only the largest macro block group, i.e. the macro block group 11, of the three macro block groups and ignores the remaining macro block groups, i.e. the macro block groups 12 and 13.

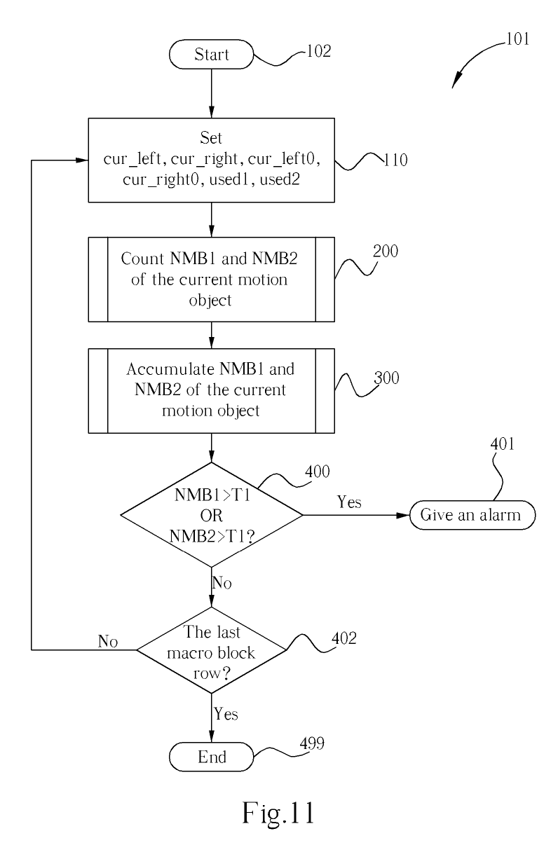

The motion detection method 1 is adopted by the video surveillance system 1010, which is assumed to generate a video frame comprising only one motion object occupying at most one macro block group in each of macro block rows of the video frame. However, in reality the video frame the video surveillance system 1010 generates can comprise a plurality of motion objects. Through a simple amendment, the motion detection method 1 can also be adopted by the video surveillance system 1010, which has the capability to generate a video frame comprising a plurality of motion objects. Accordingly, each macro block row of the video frame can comprise a plurality of macro block groups. Please refer to FIG. 11, which is a flow chart of a motion detection method 101 of a second embodiment according to the present invention. The motion detection method 101 is derived through the simple amendment to the motion detection method 1. The motion detection method 101 has the capability to detect a video frame comprising a plurality of motion objects and a plurality of macro block groups. Similarly, the motion detection method 101 counts and accumulates row by row the number of macro blocks where the motion object occupies the video frame. The motion detection method 101 comprises the following steps:

Step 102: Start;

(Both NMB₁ and NMB₂ are set to be “0”, and i is set to be “1” initially. The video surveillance system 1010 is assumed to generate a video frame comprising a plurality of macro block rows, each of which is occupied by at most two motion objects OBJ₁, and OBJ₂.)

Step 110: Initialize cur_left, cur_right, cur_left₀, cur_right₀, used₁, and used₂;

(Both (cur_left, cur_right) and (cur_left₀, cur_right₀) are set to be (0, −1), and (used₁, used₂) is set to be (0, 0) initially, where cur_left, and cur_right as well, has been defined in the previous paragraph, further description hereby omitted, cur_left₀ and cur_right₀ indicate a left margin and a right margin of a macro block segment occupied by a maximum macro block group, the largest macro block group among all macro block groups where the motion object occupies the ith macro block row of the video frame, and used₁ and used₂ are used to indicate whether the motion objects OBJ₁ and OBJ₂ occupy any macro block of the ith macro block row respectively. For example, if used₁ is equal to “0”, the motion object OBJ₁ is determined to occupy zero macro blocks of the ith macro block row; On the contrary, if used₂ is equal to “1”, the motion object OBJ₂ is determined to occupy at least one macro block of the ith macro block row.)

Step 200: Count row by row the numbers of macro blocks NMB₁ and NMB₂ where the motion objects OBJ₁ and OBJ₂ occupy the ith macro block row of the video frame respectively;

Step 300: Accumulate NMB₁ and NMB₂ up to the ith macro block row where the motion objects OBJ₁ and OBJ₂ occupy the video frame;

Step 400: Determine if NMB₁ or NMB₂ is larger than the first threshold T₁? If either of NMB₁ and NMB₂ is larger than the first threshold T₁, then go to step 401, else go to step 402;

(NMB₁ and NMB₂ indicate the numbers of macro blocks up to the ith macro block row where the motion objects OBJ₁ and OBJ₂ respectively occupy the video frame.)

Step 401: Give an alarm;

(So far, the motion detection method 101, up to the ith macro block row, has “found” at least one of the motion objects OBJ₁ and OBJ₂ of the video frame, and the motion detector 1016 of the video surveillance system 1010, which adopts the motion detection method 101, controls the alarm 1020 to issue an alarm to notify security personnel, or enables the recorder 1018 to record the video.)

Step 402: Determine if the ith macro block row is the last macro block row of the video frame? If the ith macro block row is the last macro block row of the video frame, then go to step 499, else i=i+1 and go to step 110; and

(So far, the motion detection method 101, up to the ith macro block row, cannot make a decision whether the video frame has any motion object, and have to count and accumulate the number of macro blocks NMB where the motion object occupies the remaining macro block rows succeeding the ith macro block row of the video frame.)

Step 49: End.

(So far, the motion detection method 110 has detected all of the macro blocks of the video frame and does not find any motion object.)

As described previously, the motion detection method 101 is assumed to detect a video frame having a plurality of macro block rows, each of which comprises at most two motion objects. Of course, through the increasing of the number of NMBₙ and usedₙ, a motion detection method of the present invention can be adopted by a video surveillance system capable of generating a video frame comprising a plurality of macro block rows, each of which is occupied by as many as n motion objects.

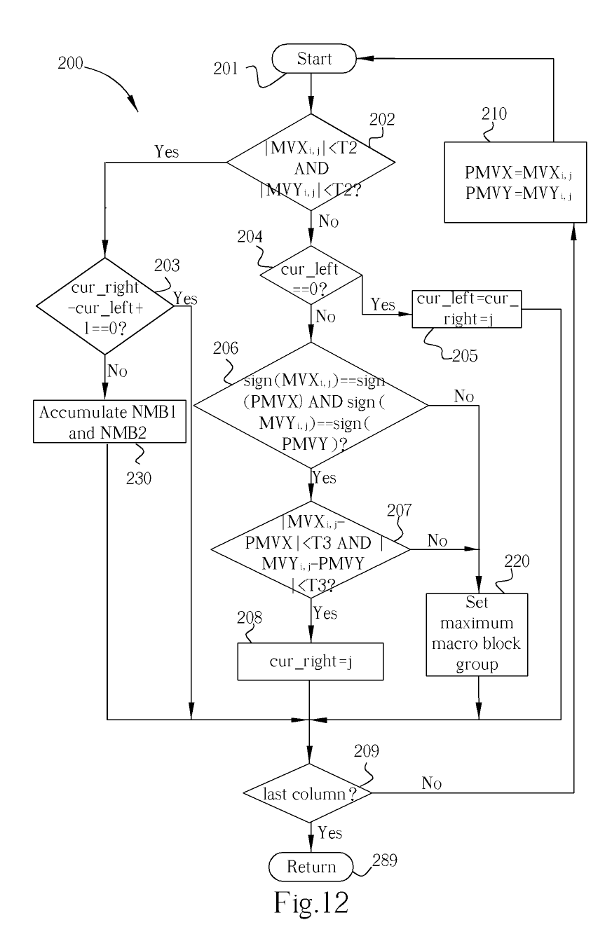

Please refer to FIG. 12, which is a flow chart of step 200 of the motion detection method 101. Step 200 comprises a plurality of steps similar to their corresponding steps of step 20 shown in FIG. 4. Step 200 comprises the following steps:

Step 201: Start;

(J is initialized to be “1”. In words, the motion detection method 101, from the first macro block column of the ith macro block row, counts the numbers of the macro blocks NMB₁ and NMB₂ where the motion objects OBJ₁ and OBJ₂ occupy the ith macro block row of the video frame column by column.)

Step 202: Determine if both |MVX_{i,j}| and |MVY_{i,j}| are smaller than the second threshold T₂? If both |MVX_{i,j}| and |MVY_{i,j}| are smaller than the second threshold T₂, then go to step 203, else go to step 204;

(If both |MVX_{i,j}| and |MVY_{i,j}| are smaller than the second threshold T₂, the macro block MB_{i,j} is determined to be a static macro block, and at least one of the motion objects OBJ₁ and OBJ₂ has ended in the jth macro block column of the ith macro block row.)

Step 203: Determine if (cur_right−cur_left+1) is equal to “0”? If (cur_right−cur_left+1) is equal to “0”, then go to step 209, else go to step 230;

(If (cur_right−cur_left+1) is equal to “0”, a current macro block group (cur_right, cur_left) indicates is determined to comprise zero motion macro block; On the contrary, if (cur_right_cur_left+1) is not equal to “0”, the current macro block group is determined to comprise at least one motion macro block.)

Step 204: Determine if cur_left is equal to “0”? If cur_left is equal to “0”, then go to step 205, else go to step 206;

(Step 204 is similar to step 23 shown in FIG. 4, further description hereby omitted.)

Step 205: Set both cur_left and cur_right to be “j”, then go to step 209;

(Step 205 is similar to step 27 shown in FIG. 4, further description hereby omitted.)

Step 206: Determine if sign(MVX_{i,j}) and sign(MVY_{i,j}) are equal to sign(PMVX) and sign(PMVY) respectively? If sign (MVX_{i,j}) is equal sign(PMVX) and sign(MVY_{i,j}) is equal to sign(PMVY), then go to step 207, else go to sep 220;

(Step 206 is similar to step 24 shown in FIG. 4, further description hereby omitted.)

Step 207: Determine if both |MVX_{i,j}−PMVX| and |MVY_{i,j}−PMVY| are smaller than the third threshold T₃? If both |MVX_{i,j}−PMVX| and |MVY_{i,j}−PMVY| are smaller than the third threshold T₃, then go to step 208, else go to step 220;

(Step 207 is similar to step 25 shown in FIG. 4, further description hereby omitted.)

Step 208: Set cur_right to be “j”, then go to step 209;

(Step 208 is similar to step 26 shown in FIG. 4, further description hereby omitted.)

Step 209: Determine if the jth macro block column is the last macro block column of the ith macro clock row? If the jth macro block column is the last macro block column of the ith macro clock row, then go to step 289, else j=j+1 and go to step 210;

(Step 209 is similar to step 28 shown in FIG. 4, further description hereby omitted.)

Step 210: Set both PMVX and PMVY to be “MVX_{i,j}” and “MVY_{i,j}” respectively, then go to step 201; and

(Step 210 is similar to step 29 shown in FIG. 4, further description hereby omitted.)

Step 220: Set the maximum macro block group of the ith macro block row;

(So far, the motion detection method 101 has determined that of the ith macro block row the jth macro block column is included in a macro block group different from that in which a (j−1)th macro block column, which is right preceding the jth macro block column, is included, and a macro block group including the (j−1)th macro block column of the ith macro block row has ended in the (j−1)th macro block column.)

Step 230: Accumulate a number of macro blocks of the maximum macro block group where the motion object occupies the ith macro block row of the video frame up to the jth macro block column of the ith macro block row; and

(So far, the motion detection method 101 has determined that at least one, which is called a current motion object, of the motion objects OBJ₁ and OBJ₂ occupies at least one macro block of the ith macro block row, and the current motion object has ended in the jth macro block column of the ith macro block row.)

Step 289: Return.

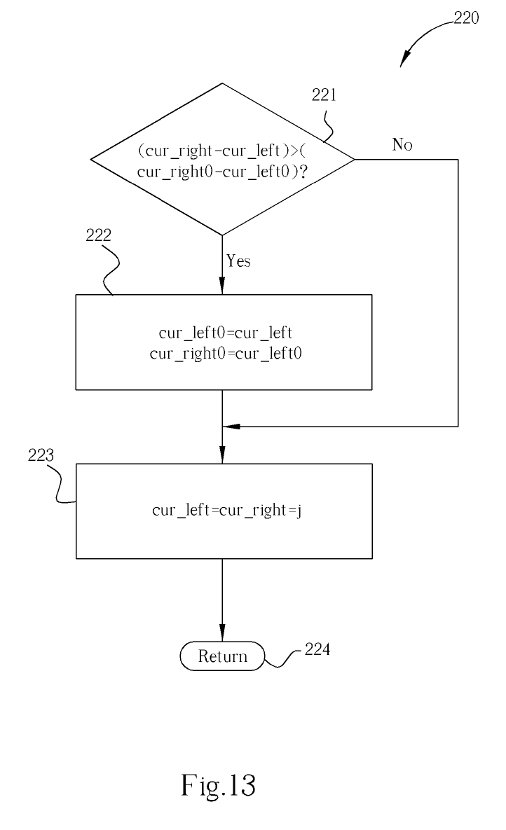

Please refer to FIG. 13, which is a flow chart of step 220 of the motion detection method 101. Step 220 comprises the following steps:

Step 221: Determine if (cur_right−cur_left) is larger than (cur_right₀−cur_left₀)? If (cur_right−cur_left) is larger than (cur_right₀−cur_left₀), then go to step 222, lese go to step 223;

(If (cur_right−cur_left) is larger than (cur_right₀−cur_left₀), the macro block group including the (j−1) macro block column of the ith macro block row is determined to be the maximum macro block group, and (cur_right₀, cur_left₀) has to be updated to be (cur_right, cur_left).)

Step 222: Set (cur_right₀, cur_left₀) to be (cur_right, cur_left), then go to step 223;

((Cur_right₀, cur_left₀) always indicates the right margin and the left margin of the macro block segment occupied by the maximum macro block group of the ith macro block row.)

Step 223: Set both cur_right and cur_left to be “j”, to step 224; and

((Cur_right,cur_left), which has been updated to be “j”, indicates a new macro block group succeeding the maximum macro block group.)

Step 224: Return.

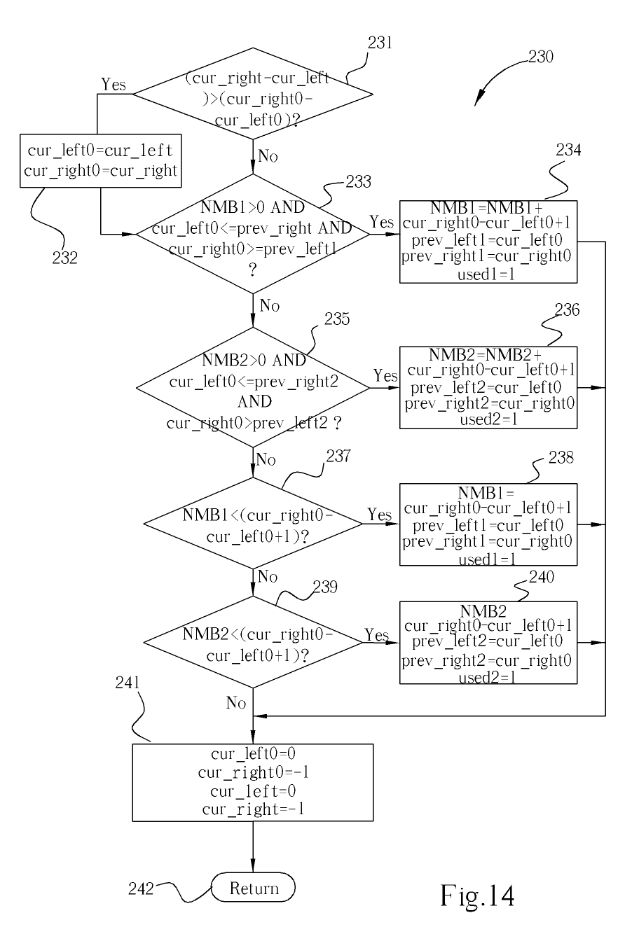

Please refer to FIG. 14, which is a flow chart of step 230 of the motion detection method 101. Step 230 comprises the following steps:

Step 231: Determine if (cur_right−cur_left) is larger than (cur_right₀−cur_left₀)? If (cur_right−cur_left) is larger than (cur_right₀−cur_left₀), then go to step 232, else go to step 233;

(So far, the motion detection method 101 has determined that the current motion object (comprising at least one macro block) in step 230 can comprise either a single macro block group ((cur_right₀, cur_left₀) indicates, the motion detection method 101 does not execute step 220 when executing step 200), or a plurality of macro block groups (which comprise a last macro block group (cur_right, cur_left) indicates, and a maximum macro block group (cur_right₀, cur_left₀) indicates. Because the last macro block group is not necessary to comprise the macro blocks less in number than those of the maximum macro block group, and the motion detection method 101 enters into steps 203 and 230 from step 202 without making any comparison between the last macro block group and the maximum macro block group in advance, the motion detection method 101 has to compare the last macro block group with the maximum macro block group to determine which one comprises more macro blocks.)

Step 232: Set (cur_right₀, cur_left₀) to be (cur_right, cur_left), then go to step 233;

((Cur_right₀, cur_left₀) always indicates the right margin and the left margin of the macro block segment occupied by the maximum macro block group where the current motion object occupies the ith macro block row of the video frame.)

Step 233: Determine if NMB₁ is larger than “0”, if cur_left₀isnot larger than prev_right₁,and if cur_right₀ is not smaller than prev_left₁? If NMB₁ is larger than “0”, cur_left₀ is not larger than prev_right₁, and cur_right₀ is not smaller than prev_left₁, then go to step 234, else go to step 235;

(The maximum macro block group where the current motion object occupies the ith macro block row is determined to overlap a maximum macro block group where the motion object OBJ₁ occupies the (i−1)th macro block row, where (prev_right₁, prev_left₁) indicates a right margin and a left margin of a macro block segment occupied by the maximum macro block group where the motion object OBJ₁ occupies the (i−1)th macro block row. If NMB₁ is larger than “0” (which indicates that the motion object OBJ₁ occupies at least one macro block of the (i−1)th macro block row, and in accordance (cur_right₀,cur_left₀) has been updated and is not equal to (0,−1) any more), cur_left₀ is not larger than prev_right₁, and cur_right₀ is not smaller than prev_left₁, the maximum macro block group where the current motion object occupies the ith macro block row is determined to overlap the maximum macro block group where the motion object OBJ₁ occupies the (i−1)th macro block row.)

Step 234:Set NMB₁ to be “NMB₁+cur_right₀−cur_left₀+1”, prev_left₁ to be “cur_left₀”, prev_right₁ to be “cur_right₀”, and used₁ to be “1”, then go to step 241;

(Having determined that the maximum macro block group where the current motion object occupies the ith macro block row overlaps the maximum macro block group where the motion object OBJ₁ occupies the (i−1)th macro block row, the motion detection method 101, in addition to accumulate (cur_right₀−cur_left₀+1) to NMB₁, (cur_right₀−cur_left₀+1) being a number of macro blocks included in the maximum macro block group where the current motion object occupies the ith macro block row, further sets prev_left₁ to be “cur_left₀”, prev_right₁ to be “cur_right₀”, and used₁ to be “1”, used₁ equal to “1” indicating that the motion object OBJ₁ occupies at least one macro block of the ith macro block row.)

Step 235: Determine if NMB₂ is larger than “0”, if cur_left₀ is not larger than prev_right₂, and if cur_right₀ is not smaller than prev_left₂? If NMB₂ is larger than “0”, cur_left₀ is not larger than prev_right₂, and cur_right₀ is not smaller than prev_left₂, then go to step 236, else go to step 237;

(Having determined that the maximum macro block group where the current motion object occupies the ith macro block row does not overlap the maximum macro block group where the motion object OBJ₁ occupies the (i−1)th macro block row, the motion detection method 101 then determines if the maximum macro block group where the current motion object occupies the ith macro block row overlaps a maximum macro block group where the motion object OBJ₂ occupies the (i−1)th macro block row, where (prev_right₂, prev_left₂) indicates a right margin and a left margin of a macro block segment occupied by the maximum macro block group where the motion object OBJ₁₂ occupies the (i−1)th macro block row. If NMB₂ is larger than “0” (which indicates that the motion object OBJ₂ occupies at least one macro block of the (i−1)th macro block row, and in accordance (cur_right₀,cur_left₀) has been updated and is not equal to (0,−1) any more), cur_left₀ is not larger than prev_right₂, and cur_right₀ is not smaller than prev_left₂, the maximum macro block group where the current motion object occupies the ith macro block row is determined to overlap the maximum macro block group where the motion object OBJ₂ occupies the (i−1)th macro block row.)

Step 236:Set NMB₂ to be “NMB₂+cur_right₀−cur_left₀+1”, prev_left₂ to be “cur_left₀”, prev_right₂ to be “cur_right₀”, and used₂ to be “1”, then go to step 241;

(Having determined that the maximum macro block group where the current motion object occupies the ith macro block row overlaps the maximum macro block group where the motion object OBJ₂ occupies the (i−1)th macro block row, the motion detection method 101, in addition to accumulate (cur_right₀−cur_left₀+1) to NMB₂, (cur_right₀−cur_left₀+1) being a number of macro blocks included in the maximum macro block group where the current motion object occupies the ith macro block row, further sets prev_left₂ to be “cur_left₀”, prev_right₂ to be “cur_right₀”, and used₂ to be “1”, used₂ equal to “1” indicating that the motion object OBJ₂ occupies at least one macro block of the ith macro block row.)

Step 237: Determine if NMB₁ is smaller than (cur_right₀−cur_left₀+1)? If NMB₁ is smaller than (cur_right₀−cur_left₀+1), then go to step 238, else go to step 239;

(Having determined that the maximum macro block group where the current motion object occupies the ith macro block row overlaps neither the maximum macro block group where the motion object OBJ₁ occupies the (i−1)th macro block row nor the maximum macro block group where the motion object OBJ₂ occupies the (i−1)th macro block row, the motion detection method 101 then determines if the maximum macro block group where the current motion object occupies the ith macro block row is larger in size the number of macro blocks NMB₁ where the motion object OBJ₁ occupies the ith macro block row up to the ith macro block column.)

Step 238: Set NMB₁ to be “cur_right₀−cur_left₀+1”, prev_left₁ to be “cur_left₀”, prev_right₁ to be “cur_right₀”,and used₁ to be “1”, then go to step 241;

(Having determined that the maximum macro block group where the current motion object occupies the ith macro block row is larger than NMB₁, that is, the old NMB₁ accumulated up to the jth macro block column of the ith macro block row is too small to be meaningful and can be ignored, the motion detection method 101 at this moment can start all over again by resetting NMB₁ to be “cur_right₀−cur_left₀+1”, prev_left₁ to be “cur_left₀”, prev_right₁ to be “cur_right₀”, and used₁ to be “1”.)

Step 239: Determine if NMB₂ is smaller than (cur_right₀−cur_left₀+1)? If NMB₂ is smaller than (cur_right₀−cur_left₀+1), then go to step 240, else go to step 241;

(Having determined that the maximum macro block group where the current motion object occupies the ith macro block row overlaps neither the maximum macro block group where the motion object OBJ₁ occupies the (i−1)th macro block row nor the maximum macro block group where the motion object OBJ₂ occupies the (i−1)th macro block row, and the maximum macro block group is not larger in size than NMB₁ the motion detection method 101 then determines if the maximum macro block group where the current motion object occupies the ith macro block row is larger in size the number of macro blocks NMB₂ where the motion object OBJ₁ occupies the ith macro block row up to the ith macro block column.)

Step 240: Set NMB₂ to be “cur_right₀−cur_left₀+1”, prev_left₂ to be “cur_left₀”, prev_right₂ to be “cur_right₀”,and used₂ to be “1”, then go to step 241;

(Step 240 is similar to step 238, further description hereby omitted.)

Step 241: Set cur_left₀, cur_right₀, cur_left₁ and cur_right to be “0”, “−1”, “0”, and “−1” respectively, then go to step 242; and

Step 242: Return.

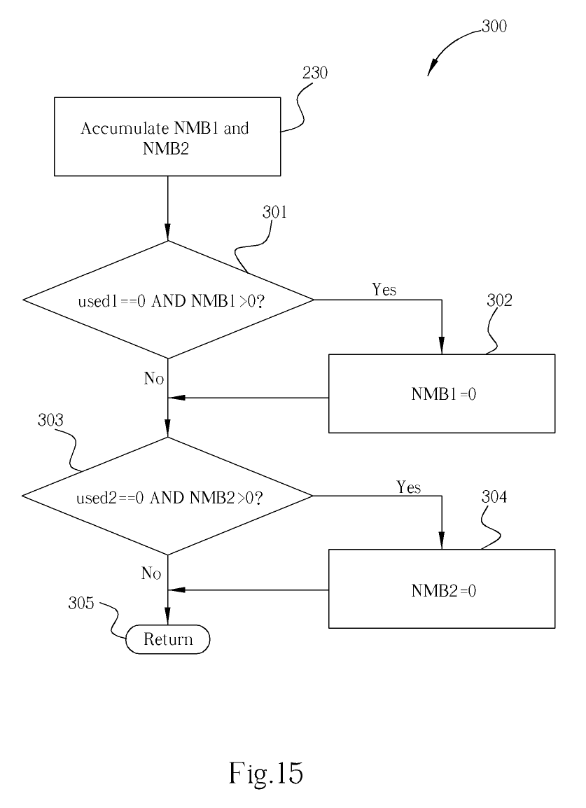

Please refer to FIG. 15, which is a flow chart of step 300 of the motion detection method 101. Step 300 comprises the following steps:

Step 230: Accumulate a total number of macro blocks included in the maximum macro block group where the motion object has occupied the video up to the ith macro block column of the ith macro block row, then go to step 301;

Step 301: Determine if used₁ is equal to “0”, and if NMB₁ is larger than “0”? If used₁ is equal to “0” and NMB₁ is larger than “0”, then go to step 302, else go to step 303;

(The motion object OBJ₁ is determined if it ends in the ith macro block row, and NMB₁ is determined if it is not equal to “0” the initial value after being used to count the number of macro blocks where the motion object OBJ₁ occupies the video frame.)

Step 302: Set NMB₁ to be “0”, then go to step 303;

(Having determined that used₁ is equal to “0”(the motion object OBJ₁ has ended in the ith macro block row), and NMB₁ is larger than “0”, the motion detection method 101 resets NMB₁ to be “0”, and NMB₁ can be now to count another motion object of the video frame.)

Step 303: Determine if used₂ is equal to “0”, and if NMB₂ is larger than “0”? If used₂ is equal to “0” and NMB₂ is larger than “0”, then go to step 304, else go to step 305;

(Step 303 is similar to step 301, further description hereby omitted.)

Step 304: Set NMB₂ to be “0”, then go to step 305; and

(Step 304 is similar to step 302, further description hereby omitted.)

Step 305: Return.

Please refer to FIG. 11 again. When used₁ in step 301 is determined to be not equal to “0”(or used₂ in step 303 is determined to be not equal to “0”), the motion detection method 101 then determines if NMB₁ is larger than the first threshold T₁ in step 400, and proceeds to either step 401 or step 402 according to the determining result.

In contrast to the prior art, the present invention can provide a motion detection method, which can be adopted by a video surveillance system. Even when a light is shining unexpectedly on a video frame the video surveillance system generates and the luminance of the video frame has changed significantly, the motion detection method still can detect if the video frame comprises any motion objects successfully. Moreover, the motion detection method does not put any restriction on the number of macro blocks the motion object occupies the video frame. Through a proper amendment of the first threshold T₁, the motion detection method can find any motion objects of any size (occupying more than or less than nine macro blocks) of the video frame.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion detection method for detecting a motion object in a video frame generated from a video surveillance system, the video frame comprising a plurality of macro blocks arranged in matrix, each of the macro block having a corresponding motion vector, and the motion detection method comprising:
determining row by row whether a current macro block of the macro blocks of the video frame has a corresponding motion vector having a predetermined characteristic;
determining whether the motion vector of the current macro block has a predetermined relation with a motion vector of a macro block preceding the current macro block;
determining whether the current macro block is located in a current macro block row having a position relation with a macro block row preceding the current macro block row where the motion object occupies the video frame, the current macro block row comprising at least a macro block whose corresponding motion vector having the predetermined relation with the motion vector of the current macro block;
counting and accumulating row by row a number of a current macro block having a corresponding motion vector determined to have the predetermined characteristic and determined to have the predetermined relation with a motion vector of a macro block preceding the current macro block, a current macro block row where the current macro block is located having been determined to have the position relation with a macro block row preceding the current macro block row where the motion object occupies the video frame; and
determining the video frame has the motion object when the number is larger than a third threshold.

2. The motion detection method of claim 1, wherein the predetermined characteristic is defined to indicate that the motion vector of the current macro block comprises a horizontal component larger than a predetermined horizontal component.

3. The motion detection method of claim 1, wherein the predetermined characteristic is defined to indicate that the motion vector of the current macro block comprises a vertical component larger than a predetermined vertical component.

4. The motion detection method of claim 1, wherein the predetermined characteristic is defined to indicate that the motion vector of the current macro block comprises a horizontal component larger than a predetermined horizontal component, and a vertical component larger than a predetermined vertical component.

5. The motion detection method of claim 1, wherein the predetermined relation is defined to indicate that the motion vector of the current macro block comprises a horizontal component whose sign is equal to that of a horizontal component of a macro block preceding the current macro block, and a vertically component whose sign is equal to that of a vertical component of the macro block.

6. The motion detection method of claim 5, wherein the predetermined relation is defined further to indicate that a horizontal difference between the horizontal component of the motion vector of the current macro block and the horizontal component of the horizontal component of the macro block, which is located preceding the current macro block, is smaller than a predetermined horizontal component, and a vertical difference between the vertical component of the motion vector of the current macro block and the vertical component of the horizontal component of the macro block is smaller than a predetermined vertical component.

7. The motion detection method of claim 1, wherein the position relation is defined to indicate that the current macro block row where the current macro block is located overlaps a macro block row preceding the current macro block row where the motion object occupies the video frame.

8. The motion detection method of claim 7 further comprising:
comparing a current left margin of the current macro block row where the current macro block is located with a preceding right margin of a macro block row preceding the current macro block row where the motion object occupies the video frame, and a current right margin of the current macro block row with a preceding left margin of the macro block row, and determining when the current macro block row overlaps the macro block row, the current left margin indicating a leftmost macro block of the current macro block row, the current right margin indicating a rightmost macro block of the current macro block row, the preceding left margin indicating a leftmost macro block of the macro block row, and the preceding right margin indicating a rightmost macro block of the macro block row.

9. The motion detection method of claim 8 further comprising:
setting the current left margin and the current right margin to be “0” and “1” respectively before counting and accumulating the number of the current macro block of the macro blocks of the video frame.

10. The motion detection method of claim 8, wherein when the current left margin is compared to be not larger than the preceding right margin, and the current right margin is compared to be not smaller than the preceding left margin, the current macro block row is determined to overlap the macro block row preceding the current macro block row where the motion object occupies the video frame.

11. The motion detection method of claim 8 further comprising:
setting the preceding left margin and the preceding right margin to be the current left margin and the current right margin respectively when the current left margin is compared to be smaller than the preceding right margin, or the current right margin is compared to be larger than the preceding left margin.

12. The motion detection method of claim 8 further comprising: comparing the current left margin with “0”.

13. The motion detection method of claim 12 further comprising:
setting both the current left margin and the current right margin to be a column number of the current macro block when the current left margin is compared to be equal to “0”.

14. The motion detection method of claim 1 further comprising:
setting the number of the current macro block to be “0” before counting and accumulating the number of the current macro block.

15. The motion detection method of claim 1 further comprising:
enabling an alarm when the video frame is determined to have the motion object.

16. The motion detection method of claim 1 further comprising:
enabling a recorder when the video frame is determined to have the motion object.

17. A motion detection method for detecting a motion object in a video frame generated from a video surveillance system, the video frame comprising a plurality of macro blocks arranged in matrix, each of the macro block having a corresponding motion vector, and the motion detection method comprising:
determining row by row whether a current macro block of the macro blocks of the video frame has a corresponding motion vector having a predetermined characteristic;
determining whether the motion vector of the current macro block has a predetermined relation with a motion vector of a macro block preceding the current macro block;
determining whether the current macro block is located in a current macro block row having a position relation with a macro block row preceding the current macro block row where the motion object occupies the video frame, the current macro block row comprising at least a macro block whose corresponding motion vector having the predetermined relation with the motion vector of the current macro block;
determining whether a current subtotal of macro blocks of the current macro block row has a predetermined magnitude relation with a reference subtotal of macro blocks of a reference macro block row where the motion object occupies a macro block row where the current macro block in located, the reference macro block row comprising at least a macro block having a corresponding motion vector having the predetermined relation with motion vectors of the remaining macro blocks of the reference macro block row;
counting and accumulating row by row a number of a current macro block having a corresponding motion vector determined to have the predetermined characteristic and determined to have the predetermined relation with a motion vector of a macro block preceding the current macro block, a current macro block row where the current macro block is located having been determined to have the position relation with a macro block row preceding the current macro block row where the motion object occupies the video frame, and the current subtotal of macro blocks of the current macro block row having the predetermined magnitude relation with the reference subtotal of the reference macro block row where the motion object occupies a macro block row where the current macro block in located; and
determining the video frame has the motion object when the number is larger than a third threshold.

18. The motion detection method of claim 17, wherein the predetermined magnitude relation is defined to indicate that the current subtotal macro blocks of the current macro block row is larger than the reference subtotal of the reference macro block row where the motion object occupies a macro block row where the current macro block in located.

19. A motion detection method for detecting a motion object in a video frame generated from a video surveillance system, the video frame comprising a plurality of macro blocks arranged in matrix, each of the macro block having a corresponding motion vector, and the motion detection method comprising:
determining row by row whether a current macro block of the macro blocks of the video frame has a corresponding motion vector having a predetermined characteristic;
determining whether the motion vector of the current macro block has a predetermined relation with a motion vector of a macro block preceding the current macro block;
determining whether the current macro block is located in a current macro block row having a position relation with a macro block row preceding the current macro block row where the motion object occupies the video frame, the current macro block row comprising at least a macro block whose corresponding motion vector having the predetermined relation with the motion vector of the current macro block; and
determining the current macro block is a macro block where the motion object occupies the video frame when the motion vector of the current macro block is determined to have the predetermined characteristic, and determined to have the predetermined relation with a motion vector of a macro block preceding the current macro block, and a current macro block row where the current macro block is located is determined to have the position relation with a macro block row preceding the current macro block row where the motion object occupies the video frame.

20. The motion detection method of claim 19 further comprising:
determining whether a current subtotal of macro blocks of the current macro block row has a predetermined magnitude relation with a reference subtotal of macro blocks of a reference macro block row where the motion object occupies a macro block row where the current macro block in located, the reference macro block row comprising at least a macro block having a corresponding motion vector having the predetermined relation with motion vectors of the remaining macro blocks of the reference macro block row, and the current macro block is determined to be a macro block where the motion object occupies the video frame further when the current subtotal of macro blocks of the current macro block row is determined to have the predetermined magnitude relation with the reference subtotal of macro blocks of the reference macro block row where the motion object occupies a macro block row where the current macro block in located.
